(19) United States
(12) Patent Application Publication
(10) Pub. No.: US 2024/0095832 A1
(43) Pub. Date: Mar. 21, 2024

(54) SYSTEM AND METHOD FOR INCORPORATING A MORTALITY RISK IN A FINANCIAL INSTRUMENT

(71) Applicants: Dario Fusato, Chicago, IL (US); Tony Derossi, Boulder, CO (US)

(72) Inventors: Dario Fusato, Chicago, IL (US); Tony Derossi, Boulder, CO (US)

(21) Appl. No.: 18/338,515

(22) Filed: Jun. 21, 2023

Related U.S. Application Data
(60) Provisional application No. 63/354,003, filed on Jun. 21, 2022.

(51) Int. Cl. G06Q 40/06

(52) U.S. Cl. CPC G06Q 40/06; G06Q 2220/00

(57) ABSTRACT

A computer method and system for processing data for a constituency of investment pool members wherein each member is a participant to an investment transaction product that is in-part dependent upon other member's investment transaction products. Initial user inputs are received for defining an investment transaction product for a user in the constituency of pool members, comprising at least an initial funding amount and one prescribed user payout age. Electronic documentation is associated with the user investment transaction product which can provide encrypted security for the user investment transaction. Upon determination of a death a portion of a pool member's funds, determined to have deceased prior to their prescribed user payout age, is reallocated to investment funds associated with surviving pool members. A determined payout distribution is provided to a pool member upon the occurrence of a pool member reaching their prescribed user payout age.

### CROSS-REFERENCE TO RELATED APPLICATION(S)

This application claims the benefit of priority under 35 U.S.C. § 119 to prior filed and co-pending U.S. Provisional Patent Application No. 63/354,003, filed Jun. 21, 2022 by Dario Fusato and Tony Derossi.

### BACKGROUND

### Technical Field

The disclosed embodiments generally relate to financial management systems and, more particularly, to a method and computing system for effecting a financial investment transaction, providing a longevity credit for pool members participating in the financial investment transaction.

### Background

Retirement planning is a complicated exercise because the future is uncertain. Nonetheless, prior art retirement calculators often employ deterministic models that output seemingly precise predicted value of a portfolio. Typically, a user is required to input a number of parameters such, for example, as a fixed rate of inflation, a fixed rate of return, and a specified retirement age. Using these user-input values, the prior art calculators compute a future value of the portfolio at the specified retirement age or at some other specified point in time. This computed portfolio value, however, is of limited use to an investor, or may even be misleading to the investor, because the chance of achieving the computed value is strongly dependent upon assumptions. As any competent investor knows, future rate of return or rate of inflation varies from month-to-month and from year-to-year, depending on a myriad of highly variable economic parameters. Moreover, one's actual life span may be shorter or longer than that published in a life expectancy table, thereby creating further uncertainties in the computed portfolio value.

Accordingly, there is a need for better financial products such has for improving the retirement planning outcome that provides increased certainty for providing financial returns upon an investor reaching a prescribed age, such as a retirement age, for achieving a retirement goal.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

Generally, the illustrated embodiments relate to a computer technological platform configured and functional to manage longevity upside (“mortality credit”) of a pooled investment. For instance, a group of investors (“the pool”) whom invest together in an index fund or EFT, which related proceedings, as well as the initial investments, are distributed among the participants that reach a pre-agreed payout age accordingly to pre-agreed fair rules. A benefit of the financial tool provided by the illustrated embodiments is effectively and securely, managing financial products providing a longevity credit while improving long term financial planning for an investor in the pool.

To achieve these and other advantages and in accordance with the purpose of the illustrated embodiments, in one aspect, described is a computer method and system for processing data for a constituency of investment pool members wherein each member is a participant to an investment transaction product that is in-part dependent upon other member's investment transaction products. Using a data processing system, initial user inputs are received for defining an investment transaction product for a user in the constituency of pool members, comprising at least: a) an initial funding amount and b) at least one prescribed user payout age. Electronic documentation is then formulated that is associated with the user investment transaction product which preferably provides encrypted security for the user investment transaction. Preferably using AI technology, the occurrence of a death is determined for one or more pool members prior to their prescribed user payout age. At least a portion of a pool member's funds, determined to have deceased prior to their prescribed user payout age, is reallocated to investment funds associated with other surviving pool members. A payout distribution is provided to a pool member upon the occurrence of a pool member reaching their prescribed user payout age wherein the payout includes funds associated with: 1) a value obtained from investment of the pool member's initial funding amount; and 2) a value obtained from funds reallocated to the pool member from other pool members determined to have deceased prior to their prescribed user payout age.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example computer/communication network utilized for the illustrated embodiments.

FIG. 2 illustrates an example network device/node utilized for providing a technological platform for implementing the illustrated embodiments in the computer/communication network of FIG. 1.

FIG. 3 illustrates certain software modules of the network device/node of FIG. 1 in accordance with the illustrated embodiments.

FIG. 4 illustrates a flowchart depicting a process for implementing a financial tool in accordance with the illustrated embodiments.

FIG. 5 illustrates an exemplary user interface provided to an investor in accordance with the illustrated embodiments.

### DETAILED DESCRIPTION

Aspects of the disclosed embodiments are shown in the following description and related drawings directed to specific illustrated embodiments. Alternate preferred embodiments may be devised without departing from the scope of the illustrated embodiments. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits, by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

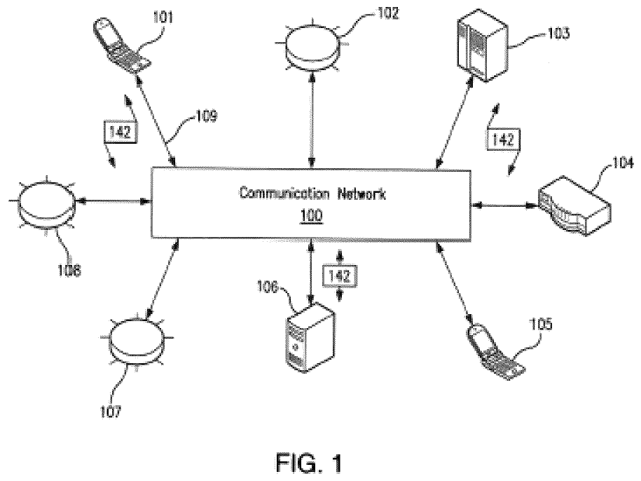

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

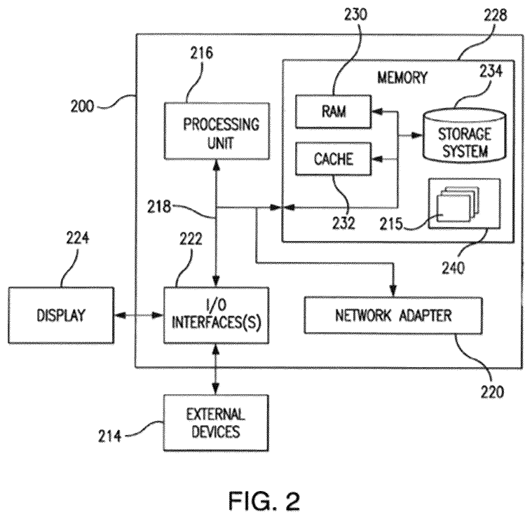

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

System/device 200 is intended to represent any type of computer system capable of carrying out the teachings of various illustrated embodiments. System 200 is only one example of a suitable system and is not intended to suggest any limitation as to the scope of use or functionality of embodiments described herein. For instance, system 200 may be configured as a cloud based computing system. Regardless, computing device/system 200 is capable of being implemented and/or performing any of the functionality set forth herein.

Computing system 200 ma be operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing system 200 may be described in the general context of computer system-executable instructions, such as program modules, being executed by a computer system. Generally, program modules may include routines, programs, objects, components, logic, data structures, and so on that perform particular tasks or implement particular abstract data types. Computing system 200 may be practiced in distributed data processing environments where tasks are performed by remote processing devices that are linked through a communications network. In a distributed data processing environment, program modules may be located in both local and remote computer system storage media including memory storage devices.

System 200 is shown in FIG. 2 in the form of a computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing system 200 typically includes a variety of computer system readable media. Such media may be any available media that is accessible by system 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215 may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

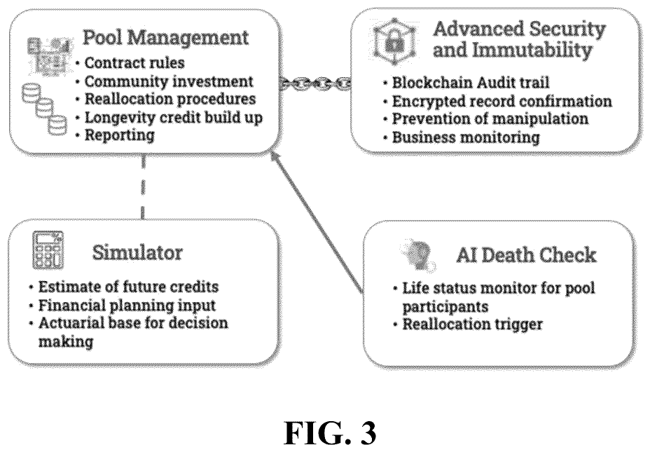

In accordance with the illustrated embodiments, and with reference to FIG. 3, program modules 215 preferably include a: 1) Management module 310; 2) Security Module 320; 3) Simulator module 330; and 4) Death check module 340.

Briefly, the Management module 310 is a software module configured and operable to manage the longevity credits accumulated within pools investing in a same portfolio of funds/ETFs. Each participant pool member is preferably characterized by his/her current age and sex at birth, a chosen payout age and a chosen initial investment. Preferably, when a participant pool member dies or leaves the pool, their shares are reallocated in a fair way amongst the surviving participants of the pool. The reallocation mechanism preferably is dependent upon the age, the actuarial death probability at that time and the initial investment amount of each one of the remaining surviving participants. A longevity credit is added to the market returns for each surviving participant that is accumulated over time, which accumulates reallocations until the designated payout age, preferably providing significant scalability of the investment pools provided by system 200.

The Security module 320 is a software module configured and operable to provide security, immutability, transparency and fairness to pool members preferably via the combined use of block chain and encryption technology. For instance, a new record relating to a transaction of a pool member (e.g., including, but not limited to: contract terms, virtual reallocation, transactions with the underlying funds/ETFs) generates a duplicate record inserted into a block chain, thus providing an audit trail of change, which block chain is preferably stored in the cloud. Exemplary functionality of the security module 320 includes (but is not limited to): data being stored in secure fixed locations (which does not cross international borders); data being stored for necessary prolonged time periods; data of pool members being associated with audit technology so as to provide proper authentication and enabling regulatory audit controls (audit verification may be provided via an API); data being encapsulated from system users/pool members and encrypted (preferably using industry standard AES256-CBC) for improved security. Thus, “human touch” is removed from encryption with key management protocols emulating “top secret” levels whereby security data is chained. Hence, not only are transactions tracked, but also tracked are users, IP addresses, errors, execution times, API calls, record exfiltration, and additional items. Accordingly, the security module 320 in accordance with the illustrated embodiments provides a technological platform that protects against data breach and record alteration so as to mitigate cyberattack risk, provides a verified policy of record, and increases efficiency and transparency for pool members.

The death check module 340 is a software module configured and operable to provide accurate and fair application of longevity credits amongst the pool members which requires prompt knowledge of the occurrence of deaths of members within the pool. It is to be understood that official data sources for determining death occurrence are the SSDI (Social Security Death Index) and the National Death Index (NDI) maintained by the CDC. However, it is to be understood and appreciated that such database records are not sufficiently accurate nor timely (they often have a backlog of recording deaths for prolonged time periods (e.g., months)). In accordance with the illustrated embodiments, death check module 340 of system 200 includes AI (Artificial Intelligence) technology specifically configured and functional to monitor/listen to numerous publically available data sources providing indication of a pool member's death. For instance, such data sources may include (but is not to be understood to be limited to): online newspapers, worshipping and obituaries; social media sources; local courthouses and genealogy sites. In accordance with the illustrated embodiments, the AI provided and utilized by the death module 340 of system 200 inspects and analyzes various publically available data sources to determine content provided by each electronic data source to extract/determine data/information regarding one or more pool member's current life status (e.g., dead or alive) based upon data collected from that information, which preferably generates a death status alert in system 200 for one or more pool members determined to have deceased. Preferably, the AI generated death status alert provided by the death module 340 of system 200 is cross-checked with pool member identity data stored in the platform of system 200.

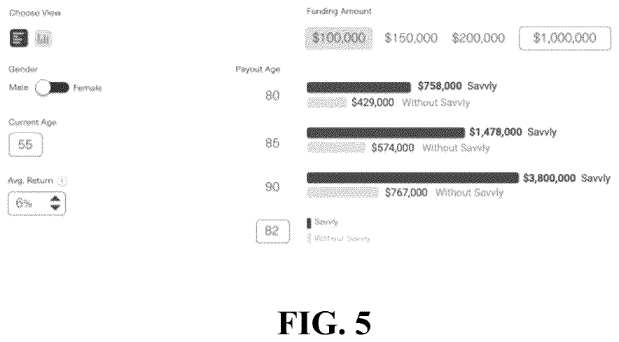

With regard to the simulator module 330 (some the functionality of which is shown in FIG. 5), it is a software module configured and operable to preferably provide an estimate of the longevity credits that will be allocated to pool members, via a graphic UI (FIG. 5 depicts the certain estimated information displayed to a user, preferably prior to subscribing to the subject financial instrument based user input data). Preferably, input to simulator module 330 is similar to that utilized to generate a position in the back end of system 200 (e.g., current age, sex at birth, investment amount) with an assumption calculation provided by system 200 providing average future market performance of the user selected funds. Additionally, actuarial mortality tables are preferably utilized to estimate the longevity credit growth over time provided to a prospective pool member. Thus, simulator software module 330 preferably includes a calculator component that utilizes an API configured to feed a web or mobile application, or to integrate with a portfolio management/financial planning tool. It is to be appreciated that the system 200 preferably tracks in real time both the market value of the common investments and of the assets from deceased pool members to surviving pool members. Hence the simulator component 330 is configured and operable to provide estimation of total investment returns at payout age and daily updates these estimates based on market performance and pool performance.

With the certain modules described above (e.g., 310-340), it is to be further appreciated that system 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

It is to be appreciated and understood, that in accordance with the illustrated embodiments, system 200 preferably includes an Application Program Interface (API) configured for integration with the Internet and/or a user mobile device software application that provides data communication with a portfolio management and/or financial planning computer software tool (including third party financial service software) associated with system 200.

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

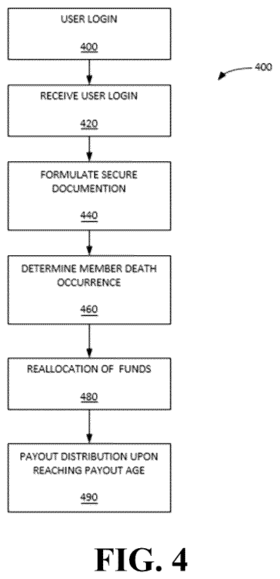

With the exemplary communication network 100 (FIG. 1) and computing device/system 200 (FIG. 2) along with certain software modules (FIG. 3) being generally shown and discussed above, description of certain illustrated embodiments of the present invention will now be provided. With reference now to FIG. 4 shown is a flow chart demonstrating implementation of the various exemplary embodiments in accordance with an exemplary process 400 for managing a financial tool providing a longevity upside (“mortality credit”) of a pooled investment, whereby a group of investors (“the pool”) collectively invest in a financial instrument (e.g., an index fund or EFT) which proceeds are distributed among the participants of the pool that reach a pre-agreed payout age accordingly to pre-agreed fair rules. As described herein in accordance with the illustrated embodiments, a benefit of the financial tool provided by process 400 is the effective and secure management of financial products providing a longevity credit while improving long term financial planning for an investor in the pool. It is noted that the order of steps shown in FIG. 4 is not required, so in principle, the various steps may be performed out of the illustrated order. Also certain steps may be skipped, different steps may be added or substituted, or selected steps or groups of steps may be performed in a separate application following the embodiments described herein.

Starting at step 410, after a user (e.g., pool member) logs into the system 200 providing the financial tool in accordance with the illustrated embodiments (preferably via authentication of user credentials), at step 420 the system 200 (preferably via management module 310) receives initial user inputs for an investment transaction product (e.g., information associated with an investment strategy (such as an index fund or EFT) for an initial funding amount, which user is a member of a constituency of pool members subscribed to the financial tool defining the investment transaction product for the pool members. For instance, such user input includes at least an initial funding amount and at least one prescribed user payout age, and also preferably the user's current age and gender identification. In accordance with the illustrated embodiments, the system 200 may be configured to permit a subscribing pool member to extend their prescribed user payout age prior to a pool member reaching their initial designated payout age (step 420)(e.g., change a payout age from 70 to 75).

Next, at step 440, the system 200 preferably formulates electronic documentation (preferably via security module 320) associated with the aforesaid user investment transaction product including security techniques for the user investment transaction. In accordance with the illustrated embodiments, the security techniques include creating an encryption hash indicator for the electronic documentation such that the electronic documentation is encapsulated from the constituency of investment pool members (and any unscrupulous users). Preferably, the encryption hash uses the Advanced Encryption Standard (AES). The encryption hash is preferably stored in a private block chain so as to provide evidence of the user's transaction wherein the private block chain creates an audit trail on the private block chain using an automatically generated encryption key for maintaining pool member's data to be immutable, auditable and transparent. For instance, preferably the block chain evidence of the user's transaction includes one or more of: contract terms; virtual reallocation of funds from other pool members, and transactions with the underlying funds/ETFs.

Once the electronic documentation is formulated (step 440), at step 460 the system 200 is uniquely configured and functional to automatically determine the occurrence of a death for one or more pool members prior to their prescribed user payout age (step 420) (preferably via death check module 340). In accordance with the illustrated embodiments, this preferably includes determining the occurrence of a death for one or more pool members by using one or more Artificial Intelligence (AI) techniques, including the use of one or more electronic data sources and/or one or more online media sources. For instance, the electronic data sources and/or one or more online media sources may include one or more: online newspapers; worshipping and obituary listings; social media websites; courthouse electronic records; and electronic genealogy data records.

In the event a pool member was determined to have deceased prior to their prescribed user payout age (step 420) at step 460, then at step 480 the process 400 for the subject financial investment tool preferably causes system 200 (preferably via management module 310) to reallocate at least a portion of the aforesaid deceased pool member's funds to investment funds associated with surviving pool members who have not yet reached their respective payout age. It is to be understood and appreciated that in accordance with the illustrated embodiments, reallocation of a pool member's assets to other pool members preferably utilizes a combination of actuarial science and risk management techniques/processes by the system 200, and it is to be further understood that the techniques/processes of system 200 accomplish such reallocation of funds in a fair and equitable distribution in view of the different ages and invested amounts relative the other pool members. Additionally, reallocating at least a portion of a pool member's funds further may preferably include distribution of a portion of the pool member's funds, determined to have deceased prior to their prescribed payout age, to prescribed heir's associated with the deceased pool member. Additionally, reallocating at least a portion of a pool member's funds, determined to have deceased prior to their prescribed user payout age, may be dependent upon the ages and investment funds associated with the other surviving pool members.

Next, at step 490, system 200 provides a payout distribution (preferably via management module 310) to a pool member upon the occurrence of a pool member reaching their prescribed user payout age (step 420) wherein the payout preferably includes funds associated with: 1) a value obtained from investment of the pool member's initial funding amount; and 2) a value obtained from funds reallocated to the pool member from other pool members determined to have deceased prior to their prescribed user payout age. The payout distribution may also associated with 3) a value obtained from funds reallocated to the pool member from other pool members who liquidated their accumulated investment funds prior to their prescribed user payout age.

Thus, in accordance with the illustrated embodiments, a payout distribution for a member preferably includes a longevity credit accumulated over time that is added to the member's market returns associated with the member's initial funding amount that cumulates reallocations from other pool members until the member's prescribed user payout age. Preferably a member may define the payout schedule and terms, such as a lump payment, distributed payment over time (which timed spaced payments my benefit from an interest bearing account and/or additional accumulated longevity credits) and/or reinvestment in another financial tool/instrument. For instance, the payout distribution may be provided in multiple payments spread apart via prescribed time periods, wherein each succeeding payout distribution is subject to further accumulation of: 1) a value obtained from investment of the pool member's initial and any subsequent funding amounts; and 2) a value obtained from funds reallocated to the pool member from other pool members determined to have deceased prior to their prescribed user payout age, wherein each succeeding spaced multiple payment is dependent upon a succeeding user prescribed payout age. For instance, a first initial payout for a member may occur at age 65, a second payout at age 68, and a third and final payout at age 75.

In accordance with the illustrated embodiments, and with reference to FIG. 5, system 200 may further be configured and functional to provide a simulation tool 500 (preferably via simulator module 330) configured and operable to estimate total investment returns for a prospective pool member's payout age, wherein the simulation tool 500 in some embodiments includes a dedicated API configured for use by a sales front end application. Additionally, the simulation tool 500 may be configured and functional to provide scheduled updates on the estimated total investment returns for a subscribing pool member based upon financial market performance and reallocation of pool members funds.

It is to be further appreciated and understood that system 200, in accordance with the illustrated embodiments is further configured to track, in real time, the market value of common investments of pool members and reallocated pool member funds. System 200 additionally may be configured and operable to enable a pool member to liquidate their accumulated investment funds prior to their prescribed user payout age whereby a portion of the pool member's funds are distributed to the liquidating pool member and another portion of the pool member's funds are reallocated to investment funds associated with other pool members (e.g., step 480). System 200 may further be configured and operable to enable a pool member to transfer their accumulated investment funds to one or more external accounts prior to their prescribed user payout age whereby a portion of the pool member's funds are reallocated to investment funds associated with other pool members (e.g., step 480) upon transfer of the investment funds to the one or more external accounts.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

1. A computer method and system for processing data for a constituency of investment pool members wherein each member has an investment transaction product that is in-part dependent upon other member's investment transaction products, comprising:
receiving, using a data processing system, initial user inputs, for defining an investment transaction product for a user in the constituency of pool members, comprising at least: a) an initial funding amount and b) at least one prescribed user payout age;
formulating electronic documentation associated with the user investment transaction product including security for the user investment transaction;
determining occurrence of a death for one or more pool members prior to their prescribed user payout age;
reallocating at least a portion of a pool member's funds, determined to have deceased prior to their prescribed user payout age, to investment funds associated with other pool members;
provide a payout distribution to a pool member upon the occurrence of a pool member reaching their prescribed user payout age wherein the payout includes funds associated with: 1) a value obtained from investment of the pool member's initial funding amount; and 2) a value obtained from funds reallocated to the pool member from other pool members determined to have deceased prior to their prescribed user payout age.

2. The computer method and system as recited in claim 1, wherein the data processing system is cloud based.

3. The computer method and system as recited in claim 1, wherein the data processing system includes an Application Program Interface (API) configured for integration with the Internet and/or a mobile device software application that provides data communication with a portfolio management and/or financial planning computer software tool (including third party financial service software).

4. The computer method and system as recited in claim 1, wherein the initial user input further includes information associated with an investment strategy for the initial funding amount.

5. The computer method and system as recited in claim 1, wherein the initial user input further includes a user's current age and gender identification.

6. The computer method and system as recited in claim 1, wherein formulating the electronic documentation includes creating an encryption hash indicator for the electronic documentation.

7. (canceled)

8. (canceled)

9. (canceled)

10. The computer method and system as recited in claim 1, wherein determining the occurrence of a death for one or more pool members includes use of Artificial Intelligence (AI).

11. (canceled)

12. (canceled)

13. The computer method and system as recited in claim 1, wherein a payout distribution for a member includes a longevity credit accumulated over time that is added to the member's market returns associated with the member's initial funding amount that cumulates reallocations from other pool members until the member's prescribed user payout age.

14. The computer method and system as recited in claim 1, wherein the data processing system is further configured to track, in real time, market value of common investments of pool members and the reallocated pool members funds.

15. The computer method and system as recited in claim 1, wherein the reallocation of a pool member's assets to other pool members utilizes combination of actuarial science and risk management techniques by the data processing system.

16. The computer method and system as recited in claim 1, wherein reallocating at least a portion of a pool member's funds further includes distribution of a portion of the pool member's funds, determined to have deceased prior to their prescribed payout age, to prescribed heirs associated with the deceased pool member.

17. The computer method and system as recited in claim 1, wherein the data processing system further includes a simulation tool configured and operable to estimate total investment returns at a poll member's payout age, wherein the simulation tool in some embodiments includes a dedicated API configured for use by a sales front end application.

18. The computer method and system as recited in claim 17, wherein the simulation tool is further configured to provide scheduled updates on the estimated total investment returns based upon financial market performance and reallocation of pool members funds.

19. The computer method and system as recited in claim 1, wherein the data processing system is further configured and operable to enable a pool member to liquidate their accumulated investment funds prior to their prescribed user payout age whereby a portion of the pool member's funds are distributed to the liquidating pool member and another portion of the pool member's funds are reallocated to investment funds associated with other pool members.

20. The computer method and system as recited in claim 1, wherein the data processing system is further configured and operable to enable a pool member to extend their prescribed user payout age.

21. The computer method and system as recited in claim 1, wherein the payout distribution is provided as prescribed by the user.

22. The computer method and system as recited in claim 1, wherein the payout distribution is provided in multiple payments spread apart via prescribed time periods, wherein each succeeding payout distribution is subject to further accumulation of: 1) a value obtained from investment of the pool member's initial and any subsequent funding amounts; and 2) a value obtained from funds reallocated to the pool member from other pool members determined to have deceased prior to their prescribed user payout age.

23. The computer method and system as recited in claim 22, wherein each succeeding time spaced multiple payment is dependent upon a succeeding user prescribed payout age.

24. The computer method and system as recited in claim 1, wherein reallocating at least a portion of a pool member's funds, determined to have deceased prior to their prescribed user payout age, is dependent upon ages and investment funds associated with the other pool members.

25. (canceled)

26. (canceled)

27. The computer method and system as recited in claim 1, wherein the data processing system is further configured and operable to enable a pool member to transfer their accumulated investment funds to one or more external accounts prior to their prescribed user payout age whereby a portion of the pool member's funds are reallocated to investment funds associated with other pool members upon transfer of the investment funds to the one or more external accounts.
